(19) United States
(12) Patent Application Publication
(10) Pub. No.: US 2008/0019805 A1
(43) Pub. Date: Jan. 24, 2008

(54) METHOD OF TRANSPORTING AND HEAT TREATING COILS OF HOT ROLLED PRODUCTS IN A ROLLING MILL

(76) Inventors: Martyn A. Bowler, Fiskdale, MA (US); Jens Nylander, Rutland, MA (US); T. Michael Shore, Princeton, MA (US)

Correspondence Address: GAUTHIER & CONNORS, LLP, 225 FRANKLIN STREET, SUITE 2300, BOSTON, MA, 02110, US

(21) Appl. No.: 11/776,864

(22) Filed: Jul. 12, 2007

Related U.S. Application Data
(60) Provisional application No. 60/831,874, filed on Jul. 19, 2006.

(51) Int. Cl. B65G 25/00; C21D 9/00

(52) U.S. Cl. 414/171; 148/559

(57) ABSTRACT

A transport path is defined by a plurality of consecutively arranged separately driven conveyor sections. A plurality of heat treating stations are spaced one from the other along the transport path. Coils are conveyed along the transport path through one or more of the heat treating stations. The speed at which the coils are conveyed on the separately driven conveyor sections is controlled to provide different transport and/or dwell times for the coils at different locations along the transport path.

### CROSS REFERENCE TO RELATED APPLICATION

This application claims priority from provisional patent application Ser. No. 60/831,874 filed Jul. 19, 2006.

### BACKGROUND DISCUSSION

1. Field of the Invention

This invention relates generally to continuous hot rolling mills producing coiled bar and rod products, and is concerned in particular with a coil handling system for centrally supporting and transporting the coils at variable rates of speed through successive stations where cooling is accelerated or retarded at controlled rates in order to impart selected metallurgical properties to the coiled products.

2. Description of the Prior Art

Conventional coil handling systems typically rely on continuous chain, walking beam or roller conveyors to transport upright coils through successive stations where cooling rates may either be accelerated or retarded. The coils are carried on pallets, and the conveyors operate at constant speeds. Transport times between stations, as well as the intervals during which the coils are exposed to thermally controlled station environments, are tied to the constant conveyor speeds. The conventional systems are thus incapable of accommodating thermal processes that require transport times between stations to vary independently of station dwell times that also may vary independently of each other.

The stations of conventional coil handling systems also have been found to be unduly limited in their ability to cool the coils at the different rates required to achieve a wide range of metallurgical properties in the coiled products.

Moreover, the upright coils are often somewhat unstable and as such are prone to toppling during transit. This is particularly the case with larger coils weighing two tons or more, and where the coiled product has a sulphur and lead content for use in automatic machines (so called “free cutting steels”).

### SUMMARY OF THE INVENTION

According to one aspect of the present invention, a transport path is defined by a plurality of consecutively arranged separately driven conveyor sections. A plurality of heat treating stations are spaced one from the other along the transport path. Upright coils are conveyed along the transport path through one or more of the heat treating stations. The speed at which the coils are conveyed on the separately driven conveyor sections is controlled to provide different transport and/or dwell times for the coils at different locations along the transport path.

According to another aspect of the present invention, one or more of the heat treating stations have tunnel enclosures with vented openings that are adjustable to achieve either retarded or accelerated cooling rates. Cooling rates may be accelerated still further by exposing the coils to forced air cooling as they progress through the tunnel enclosures.

According to still another aspect of the present invention, the coils are formed around stems projecting upwardly from the supporting pallets. The stems provide stability for the coils as they progress along the transport path.

### BRIEF DESCRIPTION OF THE DRAWINGS

FIG. 1 is a plan view of an exemplary coil handling system in accordance with the present invention;

FIGS. 2 and 3 are sectional views on an enlarged scale taken respectively along lines 2-2 and 3-3 of FIG. 1; and

FIG. 4 is a graph depicting cooling rates and transport and dwell times.

### DETAILED DESCRIPTION

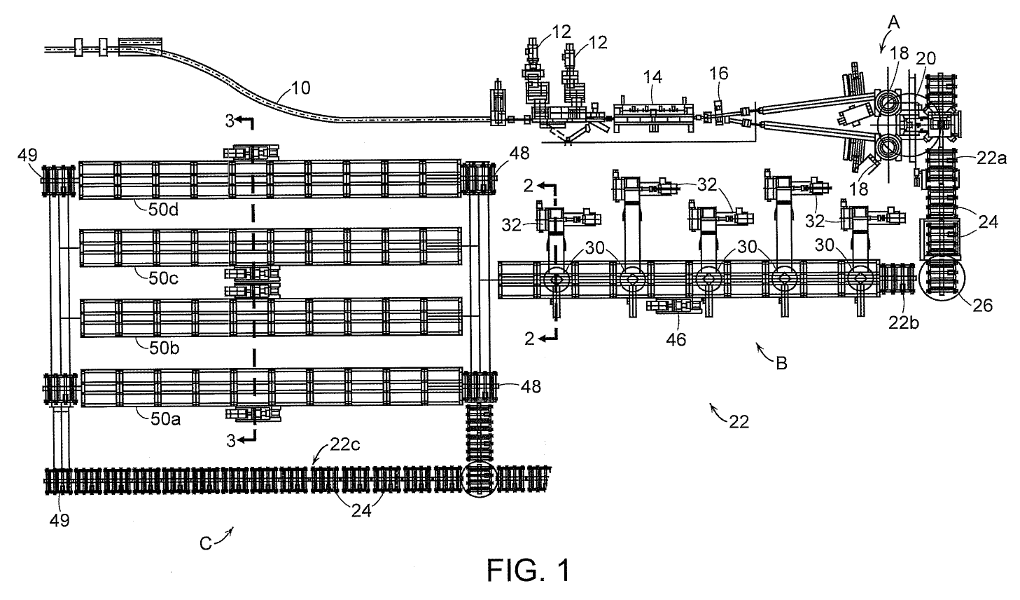

FIG. 1 depicts an exemplary layout of the delivery end of a rolling mill producing hot rolled steel bars. The hot rolled product is delivered from the rolling mill (not shown) along a path 10 leading to shears 12 which serve to crop and subdivide the product into customer lengths. The subdivided lengths are then subjected to cooling in a water box 14 before being alternately directed by a switch 16 to one or the other of two pouring reels 18 which form the product lengths into upstanding coils at a coil forming station A. A rotary table 20 then transfers the coils to the first leg 22a of a conveyor system 22 defining a transport path.

The conveyor system comprises a series of individually driven conveyor sections indicated typically at 24 which preferably will comprise short roller tables. Because the conveyor sections are individually driven, their transport speeds can be adjusted to accommodate a wide range of thermal treatments for the product coils.

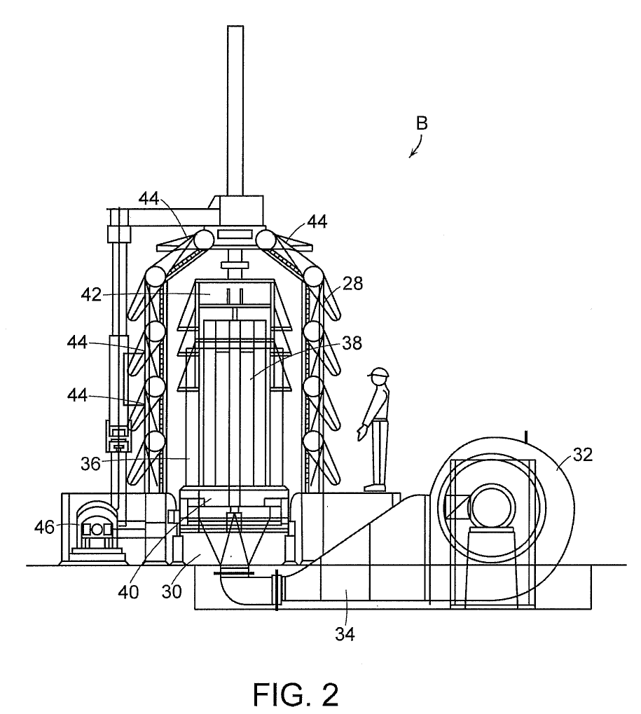

A rotary roller table 26 serves to transfer the coils from the conveyor leg 22a to a second perpendicular leg 22b leading through a heat treating station B. With additional reference to FIG. 2, it will be seen that station B includes a tunnel enclosure 28 internally provided with a series of forced air cooling installations 30. At each installation 30, a motor driven fan 32 serves to drive ambient air through a duct 34 upwardly into the interior of a coil 36. At station A, each coil is formed around a central stem 36 projecting upwardly from a pallet 40 on which the coil is supported. The stem 36 provides a central support which lends stability to the coil as it progresses along the transport path. A vertically adjustable louvered cap 42 serves to redirect the air flow radially outwardly through the coil, and external louvers 44 in the tunnel walls and roof serve to further control air flow. An external drive 46 serves to manipulate the louvers over a range of adjustments between fully open and fully closed positions. With the louvers 44 fully open and the fans 32 in operation, the coils 36 are subjected to cooling at an accelerated maximum rate. Conversely with the fans 32 shut down and the louvers 44 closed, the coils undergo retarded cooling at a greatly reduced minimum rate. A myriad of cooling rates are possible between these two extremes.

With reference again to FIG. 1, side shift transfer cars 48 receive the coils from station B and serve either to transfer them to any one of several processing lines 50a, 50b, 50c, and 50d at a second heat treating station C, or to bypass station C and transfer the coils to a conveyor leg 22c which leads to remote hook carriers and packaging equipment (not shown). Side shift transfer cars 49 receive coils from the process lines 50a, 50b, 50c, and 50d and also serve to convey them to the conveyor leg 22c.

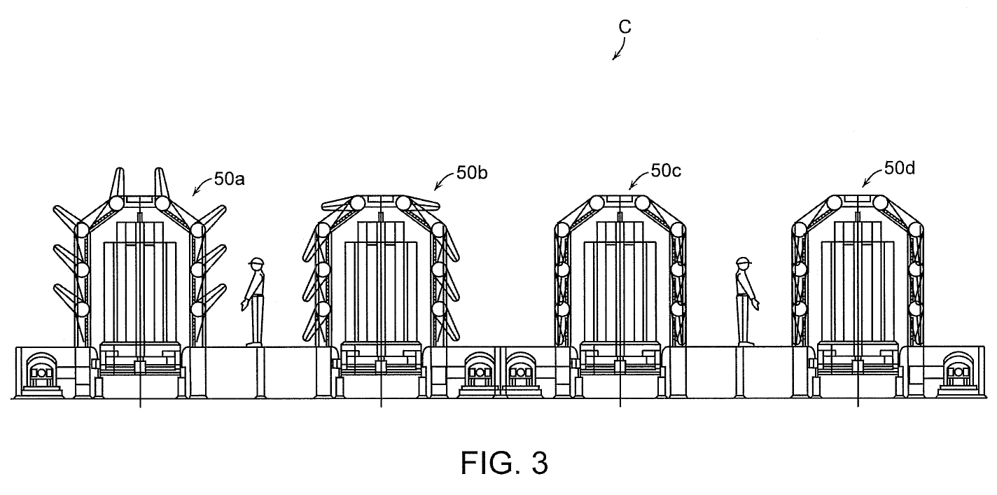

It will be seen from FIG. 3 that the processing lines 50a, 50b, 50c, and 50d each comprise louvered tunnel enclosures of the type provided at station B, but without associated cooling stations fed by forced air fans. For illustrative purposes, the louvers of processing line 50a are shown fully open, those of processing line 50b are shown partially open, and those of processing lines 50c and 50d are shown fully closed. These different adjustments respectively achieve progressively slower cooling rates.

By subdividing the conveyor system into individually driven segments, transport times between heat treating stations can be different from and beneficially faster than the transport times through the stations, the latter times being selected to coact with the rate of cooling at each station in order to achieve desired metallurgical properties in the coiled products.

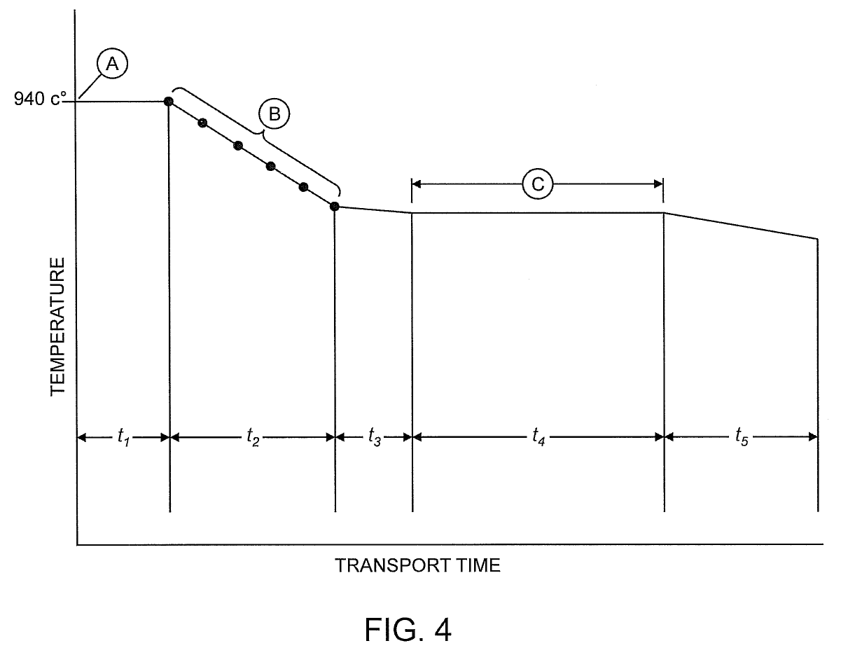

Thus, as shown in FIG. 4, the transport time t₁ between heat treating stations A and B can be relatively brief in order to limit uncontrolled cooling during that interval. The transport time t₂ through station B can be selected to achieve the desired metallurgical objective, and transport time t₃ between stations B and C can again be beneficially brief. Transport time t₄ at station C can be prolonged to again achieve the desired metallurgical objectives, and transport time t₅ can be selected to dovetail with prior process steps and to insure that the coils are delivered in a timely and coordinated sequence to the downstream hook carriers and packaging equipment.

In a typical mill environment, and by way of example only, hot rolled steel bar products are received along path 10 at temperatures on the order of 1000° C. The products are formed into coils at station A at temperatures ranging from 800°-1000° C., and are cooled to temperatures of about 600°-700° C. at station B. Retarded cooling at rates of between 0.2° to 0.5° C./sec. may then take place at station C for extended periods of up to twenty four hours.

In light of the foregoing, it will be understood by those skilled in the art that the layout shown in FIG. 1 is merely exemplary and is not intended to be limiting in the number and type of equipment components, the manner in which they are arranged, or their method of employment. Although the conveyor system has been shown as a series of individually driven roller tables, other individually driven segments such as short chain conveyor sections and short carryover beam sections could serve as equivalents. Similarly, although the tunnel enclosures have been shown with louvered openings, other mechanisms for adjusting the openings could serve as equivalents, non limiting examples being slidable doors, mutually slidable foraminous plates, etc. Also, for certain metallurgical treatments, heat may be added to the tunnel enclosures, either to further retard cooling rates or to maintain a desired soaking temperature for prolonged periods.

We claim:

1. A method of transporting and heat treating coils of hot rolled products, comprising:
providing a transport path defined by a plurality of sequentially consecutively arranged separately driven conveyor sections;
providing a plurality of heat treating stations spaced one from the other along said transport path;
conveying said coils along said transport path on said conveyor sections and through one or more of said heat treating stations; and
controlling the speed at which said coils are conveyed on said separately driven conveyor sections to thereby provide different transport and/or dwell times for said coils at different locations along said transport path.

2. The method of claim 1 wherein said coils are subjected to an accelerated cooling rate at one of said heat treating stations.

3. The method of claim 1 wherein said coils are subjected to a retarded cooling rate at one of said heat treating stations.

4. The method of claim 1 wherein the dwell time of said coils at selected heat treating stations is greater than the transport time of said coils between said selected heat treating stations.

5. The method of claim 1 further comprising forming said coils around stems projecting upwardly from pallets on which the coils are supported.

6. The method of claim 2 wherein forced air is directed upwardly into the interior of said coils.

7. The method of claim 6 wherein said forced air is redirected radially outwardly from the interior of said coils.

8. The method of claims 6 or 7 wherein said coils are enclosed in a tunnel with adjustable louvers, and wherein said accelerated cooling rate is controlled by controlling the application of said forced air and the adjustment of said louvers.

9. The method of claim 3 wherein said retarded cooling rate is achieved by retaining said coils in tunnel enclosures.

10. The method of claim 9 wherein heat is added to said tunnel enclosures.
